(19) United States
(12) Patent Application Publication
(10) Pub. No.: US 2011/0071657 A1
(43) Pub. Date: Mar. 24, 2011

(54) System for Coding and Decoding Lyrics

(75) Inventor: Chi-Chen CHENG, Taipei City (TW)

(73) Assignee: iPeer Multimedia International Ltd, Taipei City (TW)

(21) Appl. No.: 12/242,258

(22) Filed: Sep. 30, 2008

(30) Foreign Application Priority Data
Nov. 8, 2007 (TW) 096218804

(51) Int. Cl. G06F 17/00

(52) U.S. Cl. 700/94

(57) ABSTRACT

Disclosed is a system for coding and decoding lyrics. The system includes a remote control mechanism, a connector connected to the remote control mechanism, a communication interface connected to the connector, a control mechanism connected to the communication interface, an audio and video data-providing mechanism connected to the control mechanism and a lyrics-coding and decoding mechanism connected to the control mechanism. The lyrics-coding and decoding mechanism includes an algorithm unit, an authority unit connected to the algorithm unit and a lyrics database connected to the algorithm unit.

### FIELD OF INVENTION

The present invention relates to a system for coding and decoding the lyrics of songs so that a provider can code the lyrics and provide the coded lyrics to a user who can receive and decode the coded lyrics.

### BACKGROUND OF INVENTION

Computers are often connected to websites through the Internet so that to multi-media data can be downloaded to the computers from the websites through the Internet. The multi-media data can be stored in and played by the computers. Alternatively, multi-media players can be connected to the computers so that the multi-media data can be stored in and played by the multi-media players.

After the downloading, in whatever format, the multi-media data include set audio data and video data so that the users of the computers can only play, store, record and relay the multi-media data. If the multi-media data include the lyrics of songs, the users can see the lyrics while listening to the songs. There is however nothing that the users can do with the lyrics. Where the multi-media data do not include the lyrics, the users cannot see the lyrics while listening to the songs, not to say adding the lyrics to the multi-media data.

The present invention is therefore intended to obviate or at least alleviate the problems encountered in prior art.

### SUMMARY OF INVENTION

It is the primary objective of the present invention to provide a system for coding and decoding the lyrics of songs.

To achieve the foregoing objective, the system includes a remote control mechanism, a connector connected to the remote control mechanism, a communication interface connected to the connector, a control mechanism connected to the communication interface, an audio and video data-providing mechanism connected to the control mechanism and a lyrics-coding and decoding mechanism connected to the control mechanism. The lyrics-coding and decoding mechanism includes an algorithm unit, an authority unit connected to the algorithm unit and a lyrics database connected to the algorithm unit.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a partial view of a system for searching desired music according to the preferred embodiment of the present invention.

FIG. 2 is a block diagram of the system shown in FIG. 1 and a connector.

FIG. 3 is a detailed block diagram of the system shown in FIG. 2.

### DETAILED DESCRIPTION OF PREFERRED EMBODIMENT

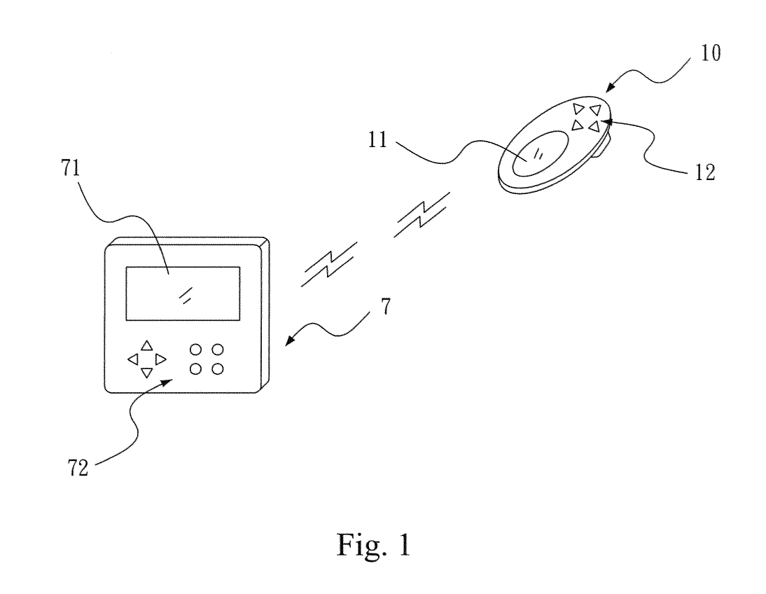

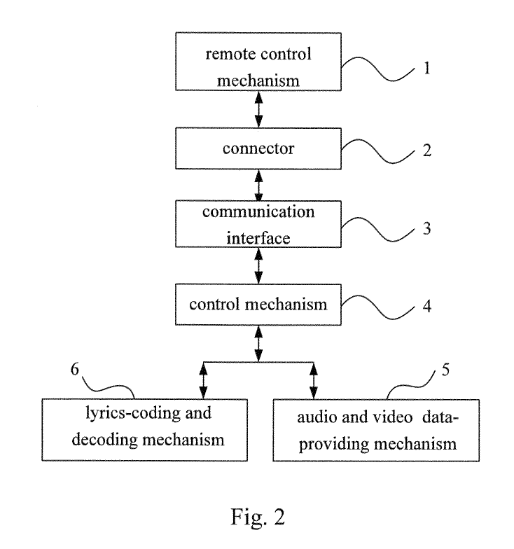

Referring to FIGS. 1 to 4, there is shown a system for coding and decoding the lyrics of songs according to the preferred embodiment of the present invention. The system includes a remote control mechanism 1, a connector 2, a communication interface 3, a control mechanism 4, an audio and video (“AV”) data-providing mechanism 5 and a lyrics-coding and decoding mechanism 6. The AV data-providing mechanism 5 and the lyrics-coding and decoding mechanism 6 are used together with each other to code and decode the lyrics so that a provider can code the lyrics of songs and provide the coded lyrics to a user of the remote control mechanism 1 and the user can receive and decode the coded lyrics.

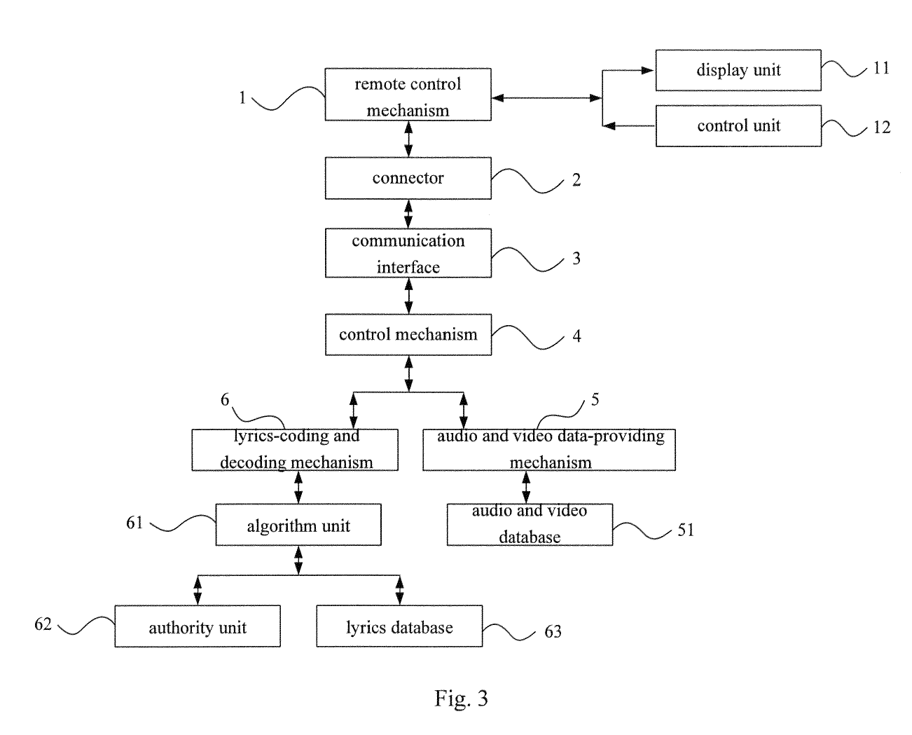

Referring to FIG. 3, the remote control mechanism 1 includes a display unit 11 and a control unit 12. The remote control mechanism 1 may be an earphone, a remote controller, a keyboard or an operative panel.

The connector 2 is connected to the remote control mechanism 1 through cables, a cable network, a wireless network or infrared communication or according to the Bluetooth communication protocol.

The communication interface 3 is connected to the connector 2.

The control mechanism 4 is connected to the communication interface 3.

The AV data-providing mechanism 5 is connected to the control mechanism 4. The AV data-providing mechanism 5 includes at least one audio and video database 51.

The lyrics-coding and decoding mechanism 6 is connected to the control mechanism 4. The lyrics-coding and decoding mechanism 6 includes an algorithm unit 61, an authority unit 62 connected to the algorithm unit 61 and a lyrics database 63.

The connector 2, the communication interface 3, the control mechanism 4, the AV data-providing mechanism 5 and the lyrics-coding and decoding mechanism 6 may be made in one piece such as an MP3 player, a laser disc player, a laser disc recorder, a computer or any other proper device.

The operation of the system will be described. The remote control mechanism Is an earphone 10 for example. The search mechanism 3 is an MP3 player 30 for example. The connector 2, the communication interface 3, the control mechanism 4, the AV data-providing mechanism 5 and the lyrics-coding and decoding mechanism 6 are included in an MP3 player 7 including a display unit 71 and a control unit 72.

In use, a user uses the control unit 12 of the earphone 10 to obtain desired songs from the audio and video database 51 through the communication interface 3 and the control mechanism 4. Then, the user uses the control unit 12 to enter identification data 621 to the authority unit 62 of the lyrics-coding and decoding mechanism 6. The identification data 621 include the name of the user, a PIN of the user, an account number of the user and a class in which the user is for example. The algorithm unit 61 calculates and confirms the identification of the user and the authorization enjoyed by the user. Then, the user uses the control unit 12 to obtain the lyrics of the desired songs from the lyrics database 63, and shows the lyrics on the display unit 11 of the earphone 10. Alternatively, the user may maneuver the control unit 72 to show the desired lyrics on the display unit 71 of the MP3 player 7.

The lyrics-coding and decoding mechanism 6 regularly changes codes so that the lyrics are provided in various formats corresponding to the codes, thus preventing none-users from stealing the lyrics. The coding is done via displacement calculation, repulsive- or calculation, switch calculation or repulsive- or displacement calculation. The decoding is done via reverse-displacement calculation, reverse-repulsive- or calculation, reverse-switch calculation or reverse-repulsive- or displacement calculation. Thus, the coding is effective so that the none-users cannot steal the lyrics, thus protecting the security of the system.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A system for coding and decoding lyrics comprising:
a remote control mechanism;
a connector connected to the remote control mechanism;
a communication interface connected to the connector;
a control mechanism connected to the communication interface:
an audio and video data-providing mechanism connected to the control mechanism; and
a lyrics-coding and decoding mechanism connected to the control mechanism and formed with an algorithm unit, an authority unit connected to the algorithm unit and a lyrics database connected to the algorithm unit.

2. The system according to claim 1, wherein the remote control mechanism comprises a display unit and a control unit.

3. The system according to claim 1, wherein the remote control mechanism is connected to the connector through cables.

4. The system according to claim 1, wherein the remote control mechanism is connected to the connector through a cable network.

5. The system according to claim 1, wherein the remote control mechanism is connected to the connector through a wireless network.

6. The system according to claim 1, wherein the remote control mechanism is connected to the connector through infrared communication.

7. The system according to claim 1, wherein the remote control mechanism is connected to the connector according to the Bluetooth communication protocol.

8. The system according to claim 1, wherein the connector, the communication interface, the control mechanism, the audio and video data-providing mechanism and the coding and decoding mechanism are made in one piece.

9. The system according to claim 1, wherein the audio and video data-providing mechanism comprises an audio and video database.
